(19) United States
(12) Patent Application Publication
(10) Pub. No.: US 2016/0381158 A1
(43) Pub. Date: Dec. 29, 2016

(54) Automatic Invitation Delivery System

(71) Applicant: Google Inc., Mountain View, CA (US)

(72) Inventors: Duncan John Curtis, Castro Valley, CA (US); Benjamin Frenkel, Santa Clara, CA (US)

(21) Appl. No.: 14/753,456

(22) Filed: Jun. 29, 2015

(51) Int. Cl. H04L 29/08

(52) U.S. Cl. CPC H04L 67/22; H04L 67/1046

(57) ABSTRACT

A method may provide, by a content distribution system, access to interactive content, such as a game, to a group of users and obtain a social media data indicating an interaction level of the users on a social network. The method may determine a content sharing rating for the users based on the social media data and select a user from the group based on the content sharing rating. The method may determine a recommendation for an incentive to be provided to the user within the interactive content, in exchange for the user performing an action to connect the interactive content to the user on a social network, such as by posting a link to the game. The method may provide the recommendation to an administrative system that administers the interactive content, such as the game developer, and that is distinct from the content distribution system.

### BACKGROUND

Viral behavior in online environments, such as where information is endorsed and shared between members of a social network, can distribute information in a rapid, relevant, and therefore efficient and valuable manner. In some cases, certain participants on social networks may be known to share information rarely, only share specific types of information, or only share information when presented with certain types of incentives. However, information owners wishing to effectively distribute their information often do not have access to this type of participant information. Rather than targeting specific social network members in specific ways, these information owners resort to attempting to engender sharing from all members in order to generate viral behavior. This can result in an excessive number of invitations reaching each member of a network, which wastes network resources, reduces the efficiency of users of the social network, and lowers the reputation of the content owner. Furthermore, all of these effects lower the probability of engendering viral behavior for the information owner in the future.

### BRIEF SUMMARY

According to an embodiment of the disclosed subject matter, a method may provide, by a content distribution system, access to an interactive content to users. The method may obtain for users of the content distribution system, a social media data indicating an interaction level of each user with one or more social media systems. The method may determine a content sharing rating for each user based on the social media data and select a first user from among the users based on the first user's content sharing rating. The method may determine a recommendation for an incentive to be provided to the first user within the interactive content, in exchange for the first user performing an action to connect the interactive content to an account of the first user on a social media system. The method may provide the recommendation to an administrative system that administers the interactive content and that is distinct from the content distribution system.

According to another embodiment of the disclosed subject matter, a method may provide, by a content distribution system, access to a first interactive content to users. The method may obtain, for a first user, a social media data indicating an interaction level of the first user with one or more social media systems. The method may determine a content sharing rating for the first user based on the social media data. The method may obtain, for the first user, an incentive history data indicating a history of responses of the first user to incentives within interactive content. The method may determine, based on the content sharing rating and the incentive history data, a recommendation of an incentive to be provided to the first user within the first interactive content in exchange for the first user performing an action associated with the first interactive content. The method may provide the recommendation to a system that administers the first interactive content and that is distinct from the content distribution system.

According to another embodiment of the disclosed subject matter, a system may include a server that may store an interactive content and a processor in communication with the server. The processor may be configured to execute instructions. The system may provide access to the interactive content to users. The system may obtain, for each user, a social media data indicating an interaction level of each user with one or more social media systems and determine a content sharing rating for each user based on the social media data. The system may select a first user based on the first user's content sharing rating and select a first incentive, from among a group of incentives, to be provided to the first user in exchange for the first user performing an action to connect the interactive content to an account of the first user on a social media system. The system may provide an indication of the incentive and an indication of the action to the first user, and receive a confirmation that the first user performed the action. The system may provide the incentive to the first user within the interactive content, in response to receiving the confirmation.

According to another embodiment of the disclosed subject matter, a means for providing, by a content distribution system, access to an interactive content to a group of users, and obtaining, for each user of the group of users, a social media data indicating an interaction level of each user of the group of users with one or more social media systems. A means is disclosed for determining a content sharing rating for each user of the group of users based on the social media data and selecting a first user from among the group of users based on the first user's content sharing rating. A means is disclosed for determining a recommendation for an incentive to be provided to the first user within the interactive content, in exchange for the first user performing an action to connect the interactive content to an account of the first user on a social media system. A means is disclosed for providing the recommendation to an administrative system that administers the interactive content and that is distinct from the content distribution system.

Additional features, advantages, and embodiments of the disclosed subject matter may be apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide further understanding of the disclosed subject matter, are incorporated in and constitute a part of this specification. The drawings also illustrate embodiments of the disclosed subject matter, and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows a system relationship according to an embodiment of the disclosed subject matter.

FIG. 2 shows a method according to an embodiment of the disclosed subject matter.

FIG. 3 shows a method according to an embodiment of the disclosed subject matter.

FIG. 4 shows a method according to an embodiment of the disclosed subject matter.

FIG. 5 shows an in-game prompt according to an embodiment of the disclosed subject matter.

FIG. 6 shows social media data of users of a content distribution system according to an embodiment of the disclosed subject matter.

FIG. 7 shows interactive content history ratings of members of a social media system according to an embodiment of the disclosed subject matter.

FIG. 8 shows a method according to an embodiment of the disclosed subject matter.

FIG. 9 shows a method according to an embodiment of the disclosed subject matter.

FIG. 10 shows an incentive history data according an embodiment of the disclosed subject matter.

FIG. 11 shows a system relationship according to an embodiment of the disclosed subject matter.

FIG. 12 shows a system according to an embodiment of the disclosed subject matter.

FIG. 13 shows a computing device according to an embodiment of the disclosed subject matter.

FIG. 14 shows a networked arrangement according to an embodiment of the disclosed subject matter.

### DETAILED DESCRIPTION

To address the issues previously discussed, techniques as described herein may provide recommendations to information owners for engendering viral sharing behavior related to their content. For example, content distribution systems that have access to social graphs of their users, such as social media platforms, may analyze the social graphs to determine those users who are most likely to share content on social networks. In general a social graph may represent connections between a user and other entities in such a network, including other users of the network. An app store associated with the social media platform may determine which users of a particular game hosted by the store are most likely to share the game. The store may then make recommendations of those users to an administrator of the game, such as the game developer or distributor. The recommendations may identify particular users as well as in-game incentives that those particular users are likely to respond to in exchange for the user sharing or otherwise interacting the game. For example, users may be presented with the option of acquiring a particular type of weapon for their game character in exchange for sharing the game on a social network. The game developer may then implement the incentives in the game for those users and thereby engender sharing.

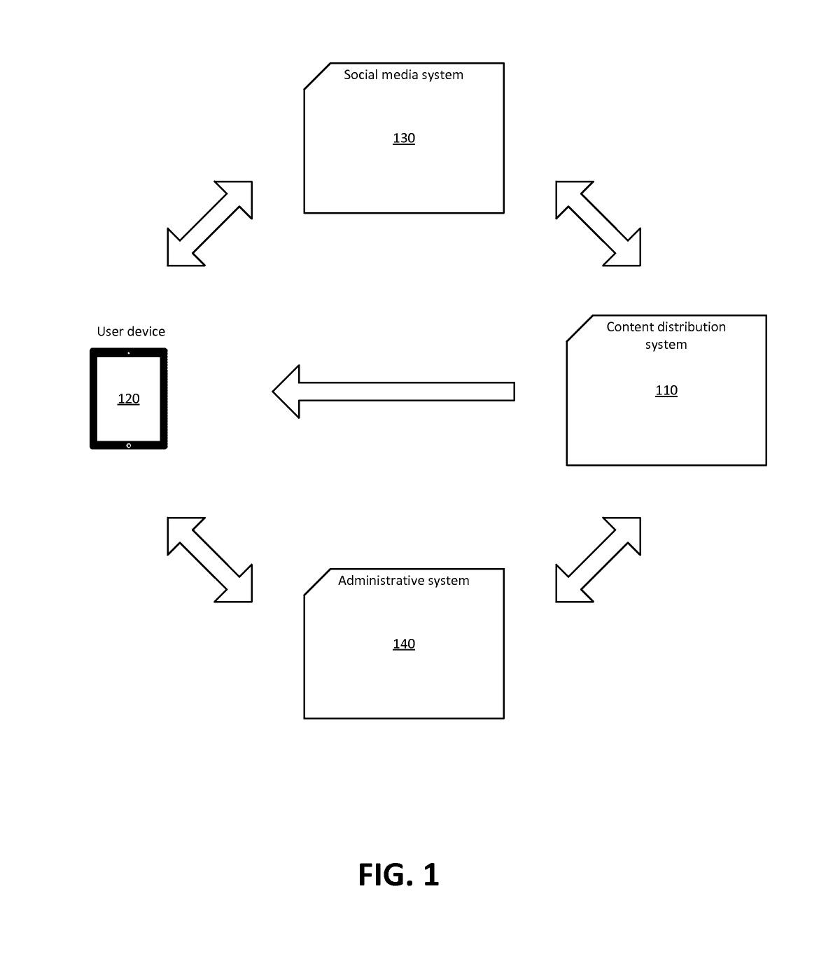

The methods and systems set forth in this disclosure may be embodied in system components having various relationships. For example, FIG. 1 shows system relationship 100 according to an embodiment of the disclosed subject matter. A content distribution system 110, such as an app store, may provide content that users may access on user devices 120, such as tablets or smart phones. Content may be interactive content where a user may perform actions within content or where a user may change content. For example, interactive content may be a game. The content distribution system may access a social media system 130, such as a social network, and obtain social media data for the users of a game. For example the content distribution system may interact with an application programming interface (API) provided by the social media system to obtain social media data about members of the social media system. The content distribution system may also operate the social media system and access social media data directly.

Content such as a game may be distributed and hosted by the content distribution system, and an administrative system 140, such as a game developer or an intermediary distributor, may have access to the game content and otherwise manage users' experience of the game. For example, the content distribution system may provide a software development kit (SDK) to game developers to develop games that may be hosted on the content distribution system. These SDKs may include application programming interfaces (APIs) that allow the content distribution system to access data about the games and game user's actions within games. An API may also enable the content distribution system to provide recommendations to the game developer for particular content, features, or functionality that may be included in their game. A game developer may also use an API to administer and manipulate game features within their game while their game is being hosted on servers maintained by the content distribution system. For example, a game developer may provide updates to game content or prompt particular users to take certain actions within their game. The content distribution system may use the access to the social media system to make recommendations to game developers for incentives to provide to game users in order to engender sharing. The game developer may implement the recommendations in the game, and as a result the user may share the game on social networks.

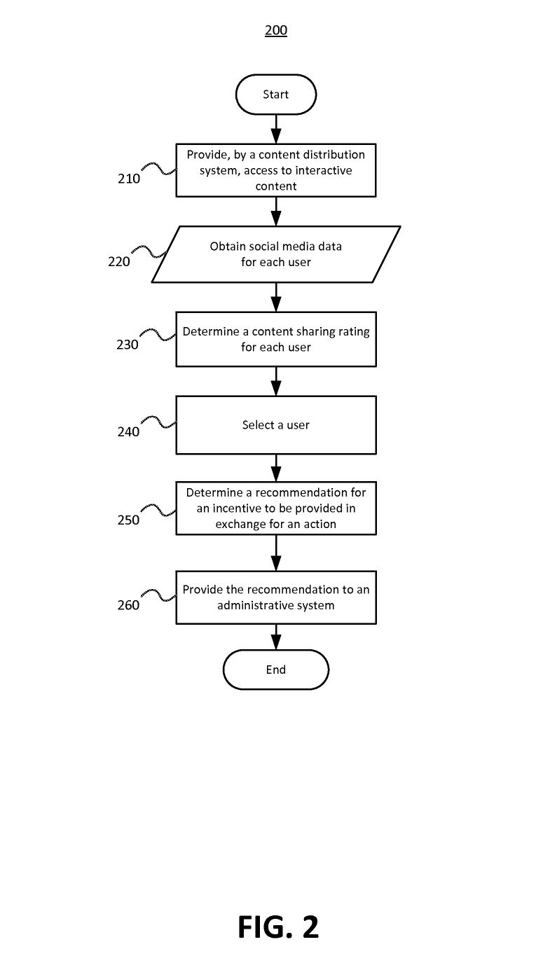

Various methods may be employed to analyze social media data of users in order to engender sharing of distributed content. For example, FIG. 2 shows a method 200 according to an embodiment of the disclosed subject matter. At 210, the content distribution system provides access to interactive content to users. The content distribution system may be an online portal where content such as apps, games, images, and videos are available for purchase, shared, or free for download over the internet. Content distribution systems may be tied to specific social network systems or may be unaffiliated and distinct. Content, including interactive content, may be made accessible on a device such as a tablet or smart phone.

At 220, the method may obtain social media data for users of the content distribution system. The social media data may be obtained from a social media system. A social media system may be a social network, a social network service, a message board, a website comment community, a messaging service, an in-game messaging network, or a peer-to-peer ad hoc messaging network.

Social media data may indicate an interaction level of a user with one or more social media systems. For example, social media data may take the form of a user's social graph. A social graph may be an arrangement of data that represents the interconnection of relationships of the user on a social network. Social media data may include the number of relationships a user has with other members on a social network, the degrees of separation between a user's relationships, the type of relationships of a user, such as whether members are friends, acquaintances, colleagues, family, and so forth.

Social media data may also include a number of actions performed by a user to connect an interactive content to an account of the user on a social media system. Connecting interactive content to an account of the user may include any action to relate the content to the user on a social media system. For example, a user may share content, such as by posting a link to the content to the user's social media account online, recommending, “liking,” or “+1-ing” the content on the social media system, sending the link to another member in a message, or posting the link to another member's account along with an indicator of the user.

Social media data may also include the number of times a member of a social network has accessed the content from the user, the type of access of that member, such as whether the member merely clicked the link or whether the member downloaded the content and interacted with it, or a percentage representing how frequently a member accesses the user's shares of content versus how many total shares of content the user has provided. The social media data may also include the number of times a member shared content first accessed by that member from a link provided by the user.

At 230, the method may determine a content sharing rating for the users based on the social media data. For example the method may determine a particular content sharing rating known as a “k-factor” for each user, and then rate each user in accordance with their k-factor. For example, a k-factor may be based on the product of the conversion percentage, which is the percentage of times a user's share actions are accessed by other members of a social network, and the total number of share actions by that user. If a user shares content with all of the user's relations, then the user's k-factor may be the product of the user's conversion percentage and the total number of the user's relations. Conversion percentages may be based on different types of access. For example, a conversion percentage may be based on following a link posted by a user, downloading content from the link, or interacting with the content downloaded from the link.

Machine learning techniques may be implemented to determine content sharing ratings for users and otherwise determine the expected value of a user's share action. Suitable machine learning techniques may include linear regression, naïve Bayes, neural networks, logistic regression, and optimized logistic regression. Machine learning techniques may analyze social media data such as the number of relations a user has on social media, the number of share actions the user has previously performed, the number of share actions the user's social media relations have performed, the number of relations of the user's social media relations, and other social media data discussed herein, included k-factors. Based on this analysis, machine learning techniques may determine an expected value of a user sharing content. This expected value may be used to rank, compare, or otherwise determine whether a user should be prompted to share content. The expected value for a user may be the user's content sharing rating.

At 240, the method may select a user from amongst the users of the content distribution system. The selection may be done based on the user's content sharing rating. For example, the users may be sorted in accordance with their content sharing rating and a percentage of the top rated users may be selected. Also, each user's content sharing rating may be compared against a content sharing rating threshold, and only those users above the threshold may be selected. The rating threshold may be selected based on the degree of breadth of communication desired, or the need to avoid unwanted share requests. For example, a lower threshold may be selected when reputational concerns are not significant, or a higher threshold may be chosen when the content at issue has a narrow range of appeal.

At 250, the method may determine a recommendation for an incentive to be provided to the user in exchange for the user performing an action. There may be various potential incentives and actions, and based on the user's content sharing rating, an action that shares the content may be chosen. The incentive may be an incentive presented to the user within the content. An incentive may be an aspect of the interactive content that is accessed more quickly or more easily if the user performs an action paired with the incentive. For example, the content may be interactive content that is a game, and the incentive may be a new level that is more quickly accessed within the game when the user shares a link to the game on a social network. Incentives may also be aspects of the interactive content that are not accessible until the user preforms an action paired with the incentive. Additional discussion of incentives and actions is included below.

An action of a user may be to connect an interactive content to an account of the user on a social media system. Such actions may include any action to relate the content to the user on a social media system. For example, a user may share content, such as by posting a link to the content to the user's social media account online, such as the user's “wall” or “page” or “timeline”; recommending, “liking,” or “+1-ing” the content on a social media system; sending the link to another member in a message from a username associated with the user; posting the link to another member's account along with an indicator of the user, such as a username or an avatar; posting the link to a comments section on a website, such as a website that reviews online games; posting the link to a blog of another member of a social media system; posting the link on the user's blog, or providing the link in a location associated with the user in an virtual online environment, such as the user's online virtual “dwelling.”

At 260, the method may provide the recommendation to an administrative system that administers the content and that is distinct from the content distribution system. For example, the administrative system may be a game developer that manages the content of the game and can manipulate aspects of the game in order to implement recommendations. As another example, the administrative system may be that of a distributor, such as a game distributor that manages titles from multiple developers and interfaces with the content distribution system on behalf of those developers. Recommendations may be structured such that they do not disclose any underlying data upon which they are based. For example a recommendation may be based on extensive social media data that must be protected from disclosure outside of the content distribution system or social media system due to privacy concerns or contractual obligations. Therefore the recommendation may be a simple string instruction returned to the game developer that may be used to identify a particular incentive, action, user, or share recipient, while omitting the underlying social media data on which the recommendation is based.

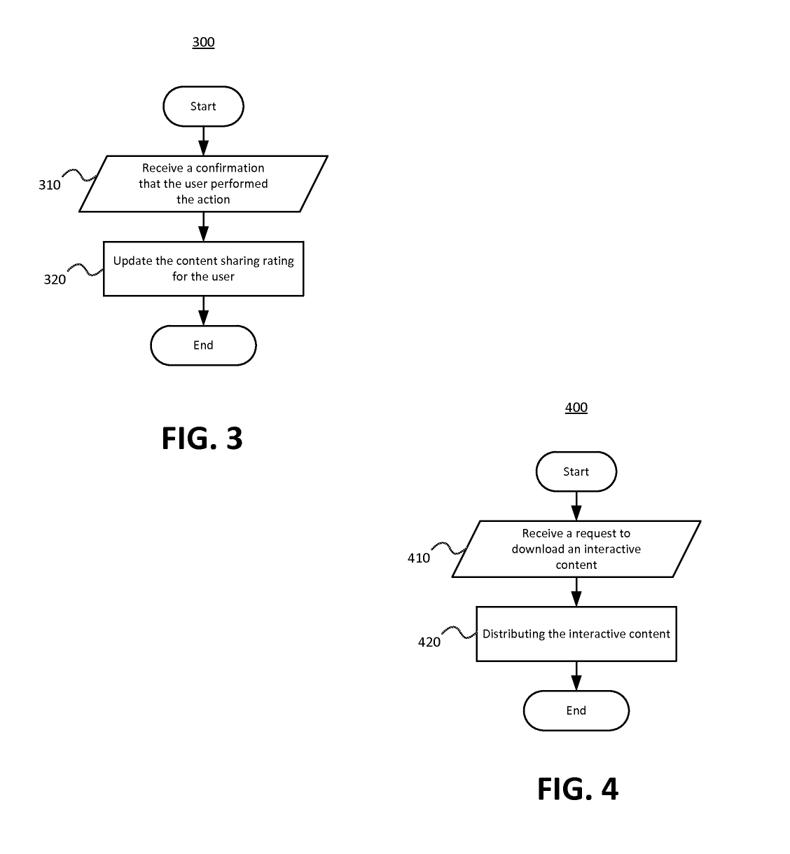

Results of method 200 may be returned to the content distribution system and used to improve content sharing ratings of users as well as to generate further downloads or other activities within the content. For example, according to an embodiment, FIG. 3 shows a method where, at 310, a confirmation that the user performed the action in response to the incentive may be received and, at 320, the user's content sharing rating may be updated. For example, the number of share actions of the user may be increased and, depending upon the effect of the user's share action, the user's conversion percentage may be increased or decreased. In addition, as shown in FIG. 4, according to an embodiment, a member of the user's social network may access the link and request a download of the content at 410. At 420, in response to the request, the content distribution system may distribute the content to a device associated with the member.

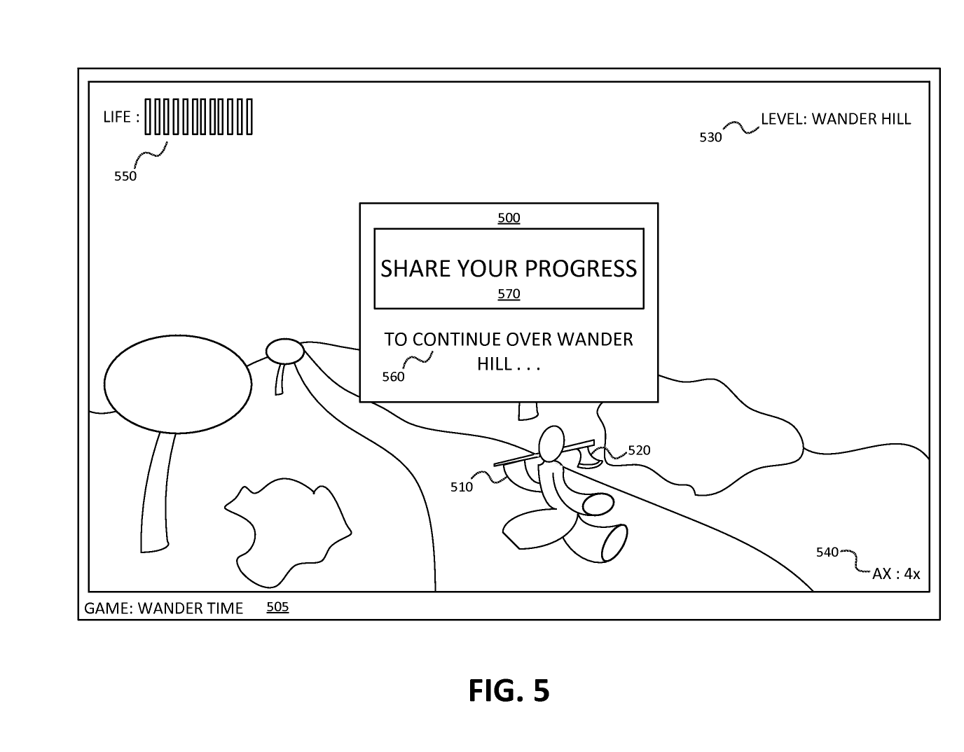

Incentives may be presented to users as additional content within interactive content. For example, FIG. 5 shows an in-game prompt 500 according to an embodiment of the disclosed subject matter. As shown, a user may play an adventure game 505 called Wander Time having a character 510, weapon 520, game level 530, weapon strength 540, life strength 550, incentive 560, and action 570. The user may play the game successfully such that she has almost completed the level Wander Hill. However, before the user travels over Wander Hill, she is presented with a prompt to share her progress. By activating the “share your progress” button, the user may post the fact that she has completed Wander Hill to her account on a social media website, as well as a link to the game Wander Time on a content distribution system. In exchange for clicking the button, the user may receive the incentive of continuing over Wander Hill and on to the next level (Wander Valley).

Aspects of the character, weapon, game level, weapon strength, and life strength may also be presented to the user as incentives in exchange for the user performing an action. For example, the user may be presented with a new character, or the weapon strength may be increased from 4× to 5×. Other incentives may include a map, a quest, storyline, a population, a unit, a tool, an ammunition, a health level, a currency, a food, a skill, a power, or an experience level. Similar incentives may be presented in other types of games. For example, easier access to new types of puzzles may be presented in puzzle games, or faster access to historical teams may be presented in sports games. More generally, any available aspect of an interactive content item may be accessed in connection with such an incentive. Similarly, any aspect of an interactive content item that may be available in other ways, such as in-app purchasing, may be made available as an incentive as disclosed herein.

Incentive and action pairings may be presented as prompts within interactive content in a variety of formats. For example, prompts may be presented as pop-up windows within the interactive content, as messages within the storyline of the content, or as objects within the portrayed environment of the interactive content, such that the prompt is triggered when a user attempts to interact with the objects. Incentive and action pairings may also be presented outside of the content, such as within a new window on an operating system presenting the content.

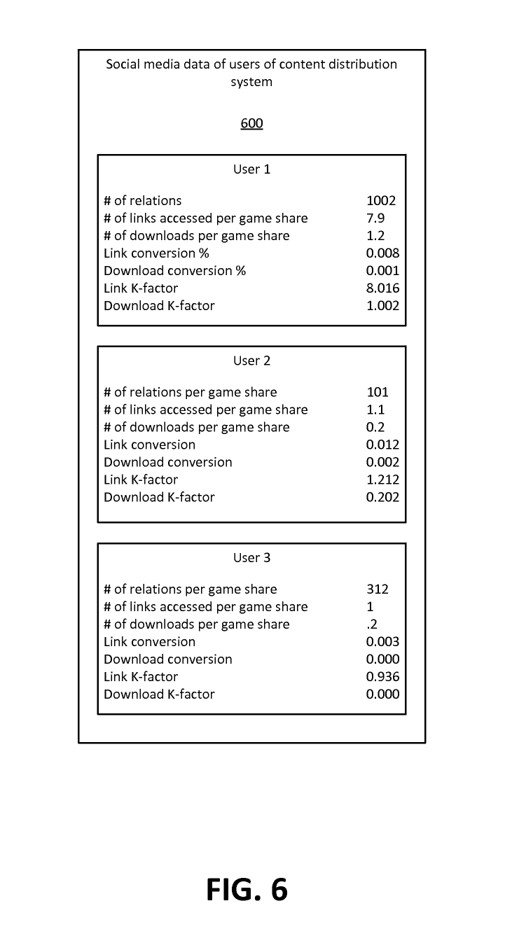

As discussed above, whether a user receives a prompt to share content may be determined based on social media data for the user. For example, FIG. 6 shows a table 600 listing social media data of users of a content distribution system according to an embodiment of the disclosed subject matter. As shown, a link k-factor may be a k-factor based on the product of a total number of share actions by a user to share a link to content and the percentage of share recipients that access the link. Users may be selected based on a threshold of a link k-factor over 1.0. According to this threshold, User 1 and User 2 may be selected to receive in-game prompts to share their interactive content. User 3 may be presented with some other form of prompt, such as a request to view advertising or a request to pay money in connection with progressing in the game. In another example, a download k-factor may be a k-factor based on the product of a total number of share actions by a user to share a link to content and the percentage of share recipients that access the link and download the content. A user may be chosen based on the top third of download k-factors. As a result, only User 1 may be selected.

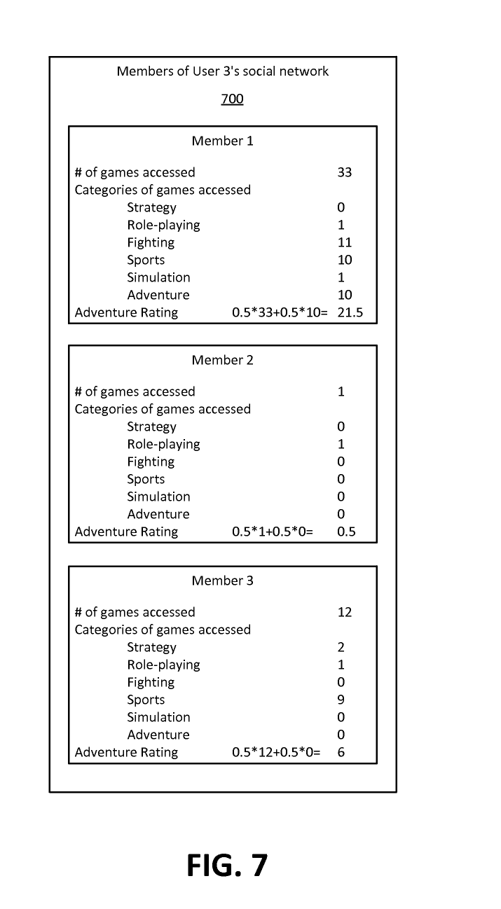

In addition to recommending which users should receive prompts to share interactive content, particular recipients of sharing actions may also be recommended. For example, FIG. 7 shows a table 700 listing interactive content history ratings of members of a social media system according to an embodiment of the disclosed subject matter. Interactive content accessed by users that are also members of a social network of a user may be tracked by the content distribution system. The interactive content may be a game and the game may be categorized as strategy, role-playing, fighting, sports, simulation, or adventure. Furthermore, an interactive content history rating may be generated for each member and used to determine which social media member to recommend.

In an example, User 1 may have downloaded Wander Time, which is categorized as an adventure game. As discussed previously, User 1 may be selected to receive an in-game incentive to share based on her content sharing rating. Member 1, Member 2, and Member 3 may each belong to User 1's social network. The choice of recipients to recommend may be based on a comparison of each member's adventure rating to a rating threshold. For example, an adventure rating may be generated based on the sum of the total number of games accessed by the member and the number of adventure games accessed by the member, each weighted by 0.5. The rating threshold may be set to 15. As a result, Member 1 of User 1's social network may be selected as the recommended recipient of User 1's sharing action because only Member 1's adventure rating exceeds 15. The share action may be posting to the social media account of Member 1, a message indicating User 1's progress and a link to access Wander Time on the content distribution system. More generally, each entity in a user's social network may be ranked generally, or in relation to a specific item of interactive content.

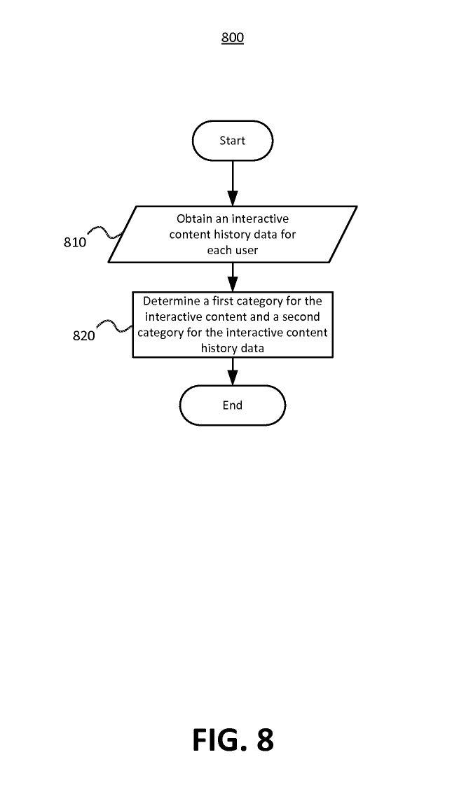

Categories associated with interactive content history or a user's interactive content may be known or may be determined dynamically. For example, FIG. 8 shows a method 800 according to an embodiment of the disclosed subject matter where interactive content history may be obtained for each user of a content distribution system at 810. At 820, the method may determine a category for the interactive content being viewed by a user and a category for the interactive content contained in the interactive content history data of a social media system. Machine learning techniques may be implemented to analyze data associated with content, such as titles, summaries, reviews, uniform resource locators, tags, and related data and meta data. Similarly, machine learning techniques may also be implemented to analyze signals associated with content such as audio and video signals. Based on this analysis, machine learning techniques may be implemented to categorize and compare content to determine whether a member of a social network would be likely to act on a share action from a user. Suitable machine learning techniques may include any of those discussed in this disclosure.

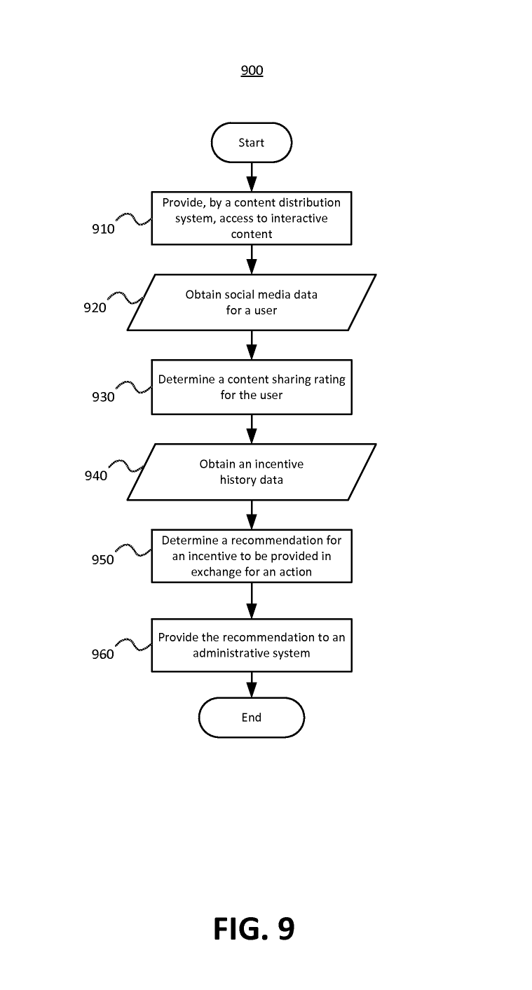

In addition to selecting a user to prompt for a share action and recommending a recipient to receive the share action from a user, a particular incentive and action may be recommended based on a user's history of responses to incentives. For example, FIG. 9 shows a method 900 according to an embodiment of the disclosed subject matter where an incentive may be recommended. A content distribution system may provide access to interactive content at 910, and the method may obtain social media data for a user at 920 and determine a content sharing rating for the user at 930. At 950, the method may obtain an incentive history data for the user. For example, an administrative system that manages the interactive content may track each user's response to different types of incentives as an incentive history data. The content distribution system may interact with the administrative system and obtain this incentive history. Based on the user's incentive history, the method may determine a recommendation for an incentive to be provided to the user in exchange for the user performing an action at 950. For example, the user may have historically taken actions in response to incentives that accelerate access to new levels 78% of the time but only responded to new units 34% of the time. The method may select the highest percentage incentive and at 960 the method may provide the recommendation of a new level incentive to the administrative system. Selection of incentives may be based on a user's historical responses to incentive categories and determined in accordance with the machine learning techniques discussed in this disclosure.

Actions may include actions other than actions to connect interactive content to an account of a user on a social media system. Actions may be any action associated with the interactive content. For example, actions may include viewing an advertisement. Advertisements may be presented to a user within interactive content. For example, a user may be playing an online game and be presented with a prompt in a pop-up screen that delays further progress in the game until an advertisement has been viewed for a period of time. An action may be a request for the user to review a product or take a survey in exchange for receiving early access to a new unit in the game. An action may also be a request to transfer a unit of monetary value from the user to an entity associated with the game, such as the game developer, in exchange for additional game credits. The unit of monetary value may be, for example, money in an account of the user, credits in an account of the user that may be used to access the game, or virtual currency. Actions may be performed in exchange for any of the incentives previously discussed.

Actions may also include not presenting a prompt to perform an action. In some circumstances, it may be determined that a user would be most likely to quit a game or other content rather than perform any action. For example, a user's social media data may indicate that the user has a low expected value for his share actions, and the user's incentive history data may indicate that the user has been presented with several share prompts in the past and has always chosen to stop playing rather than to share a game or other interactive content. Also, the incentive history data may indicate the user has been prompted to view advertisements and asked for payment several times in the past and has almost always chosen to stop playing rather than share. In these circumstances, it may be more valuable to the game developer for the user to continue playing the game rather than be prompted with an incentive and quit. Therefore the incentive and share action may be determined to be to refrain from presenting an incentive and action prompt to the user.

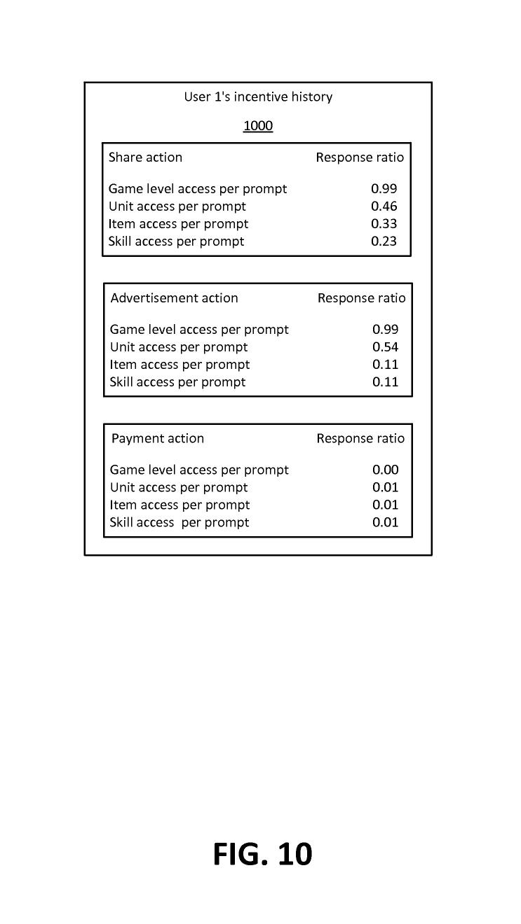

FIG. 10 shows a table 1000 indicating an incentive history data according an embodiment of the disclosed subject matter. As shown, User 1 may respond to different incentives differently. For example, User 1 may historically perform a share action 99% of the time in response to a prompt for an incentive that decreases a delay in accessing further game levels. Conversely, User 1 may have never performed a payment action in response to a prompt for an incentive that speeds up access further game levels. User 1 may have historically agreed to view an advertisement 54% of the time in response to an incentive presented in connection with a new unit in a game, and may only have agreed to perform a share action 46% of the time for the same incentive. Machine learning techniques may be implemented to determine which incentive and action combination would carry the best expected value for a user. Suitable machine learning techniques may include any of those discussed in this disclosure. For example, historical data associated with incentives such as the names of levels and weapons, products in advertising, or quantities of money may be analyzed and categorized and then compared to user actions in response to those incentives using machine learning techniques.

In some circumstances a user may be determined to have a high share rating based on social media data. However the user's incentive history data may indicate that the user has a higher likelihood of quitting a game if prompted with a share request than if prompted with an advertisement for a particular incentive. In such circumstances the particular incentive may be the only incentive available. Expected value ratings may be determined for sharing actions and advertising actions for the user. These values may be based on the impact of the actions such as the revenue returned to the game developer for each action, and may be determined by machine learning techniques. The expected value of the share action may be 7.2, and the expected value of the advertising action may be 6.9. The advertising action may be determined based on a comparison of the product of the performance percentage of each action and their expected value. For example, using the percentages for the sharing action and advertising action for the new unit incentive shown in table 1000, the advertising action product would exceed the sharing action product, 3.73>3.31.

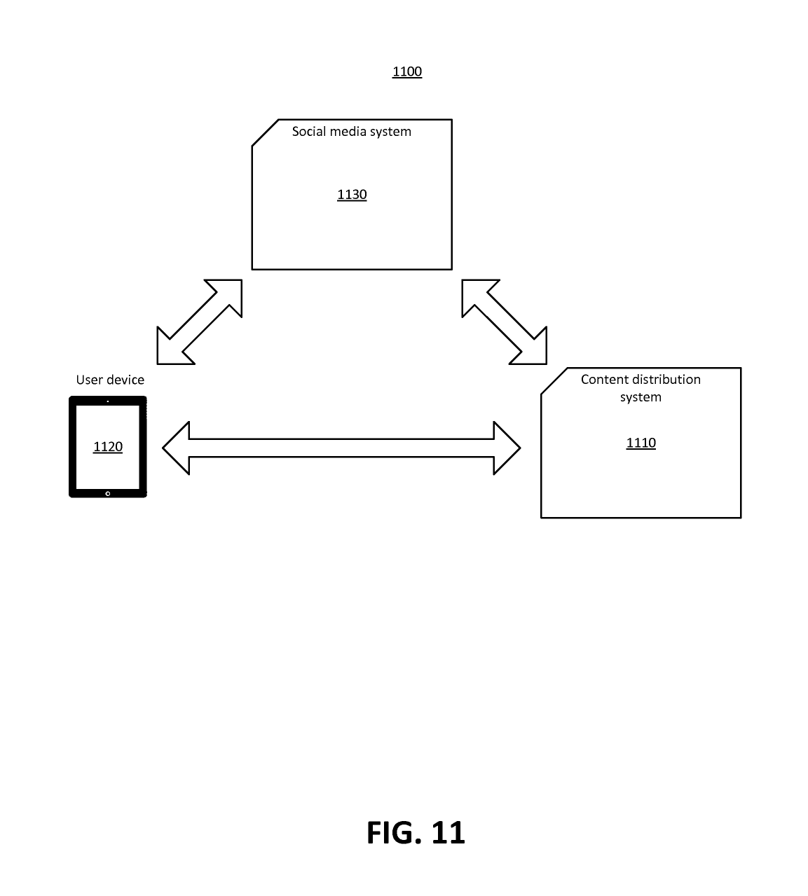

The methods and systems set forth in this disclosure may be embodied in system components having alternate relationships to those previously discussed. For example, FIG. 11 shows system relationship 1100 according to an embodiment of the disclosed subject matter. A content distribution system 1110, such as an app store, may provide content such as games that users may access on user devices 1120, such as tablets or smart phones. The content distribution system may access a social media system 1130, such as a social network, and obtain social media data for the users of a game. The content distribution system may use the access to the social media system to determine incentives to provide to the users to engender sharing of the content on social media systems.

In system relationship 1100, the game may be distributed, hosted, and administered by the content distribution system. The content distribution system may provide an SDK to game developers that includes structured incentive and action functionality, such that in order for the game to be offered on the content distribution system, it must provide certain in-game incentive and action pairings. For example, the SDK may require game developers to specify the content of tool and level incentives to users of the game in exchange for the user sharing the game on a social network. The SDK may also specify level progression structures and unit functionality, such that the overall game play of the game is standardized. Game developers may provide storyline content and graphic content within this standardized structure. Once a game is developed and offered on the content distribution system, the administration of the game may be managed by the content distribution system.

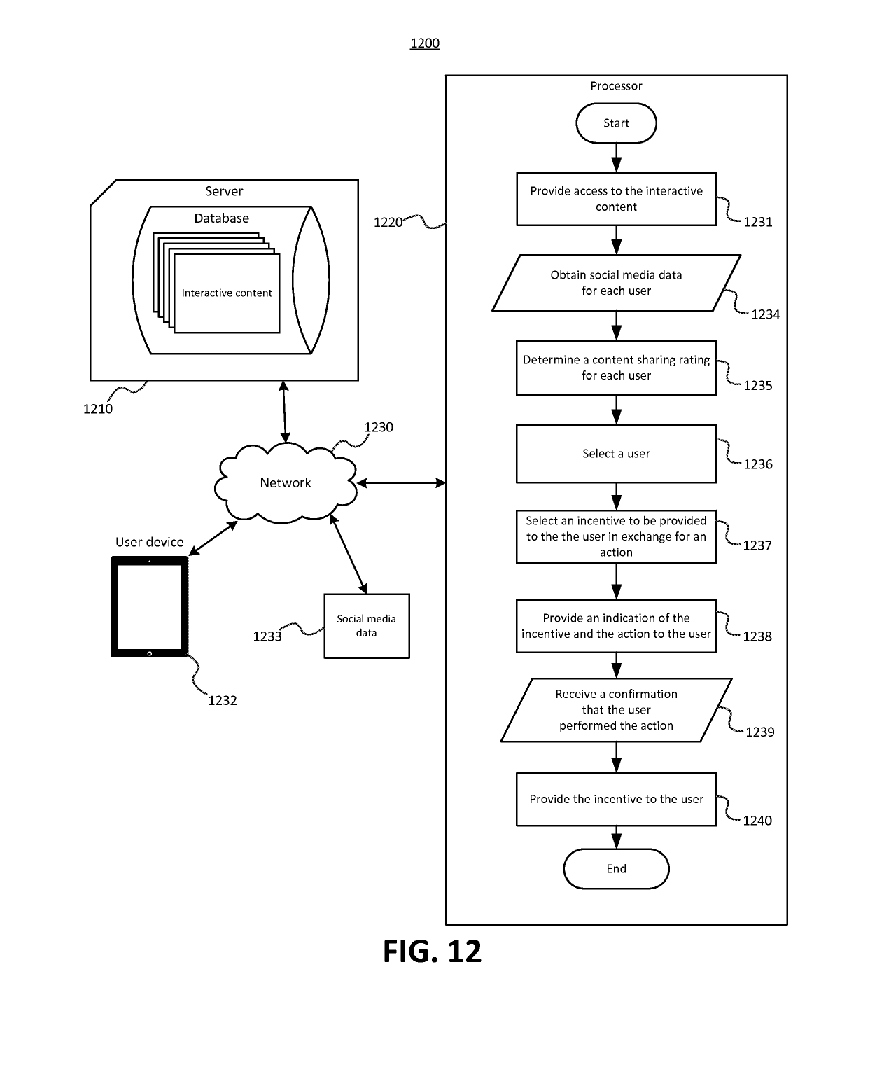

Determinations of when and what type of incentives to be presented to users may be made directly by the content distribution system in accordance with the techniques discussed in this disclosure. For example, FIG. 12 shows a system 1200 according to an embodiment of the disclosed subject matter. The system may include a server 1210 storing interactive content in a database. The system may include a processor 1220 in communication with the server over a network 1230. The processor may be configured to cause the system to provide access to interactive content at 1231 to a user device 1232. The processor may be configured to cause the system to obtain social media data 1233 at 1234 and determine a content sharing rating for users of the content distribution system at 1235. The processor may be configured to cause the system to select a user at 1236 and select an incentive to be provided to the user in exchange for an action at 1237. At 1238, instead of providing a recommendation to an administrative system, the processor may be configured to cause the system to provide an indication of the incentive and an indication of the action directly to the user, such as within the interactive content. At 1239 the processor may be configured to cause the system to receive a confirmation that the user performed the action and at 1240 provide the incentive to the user.

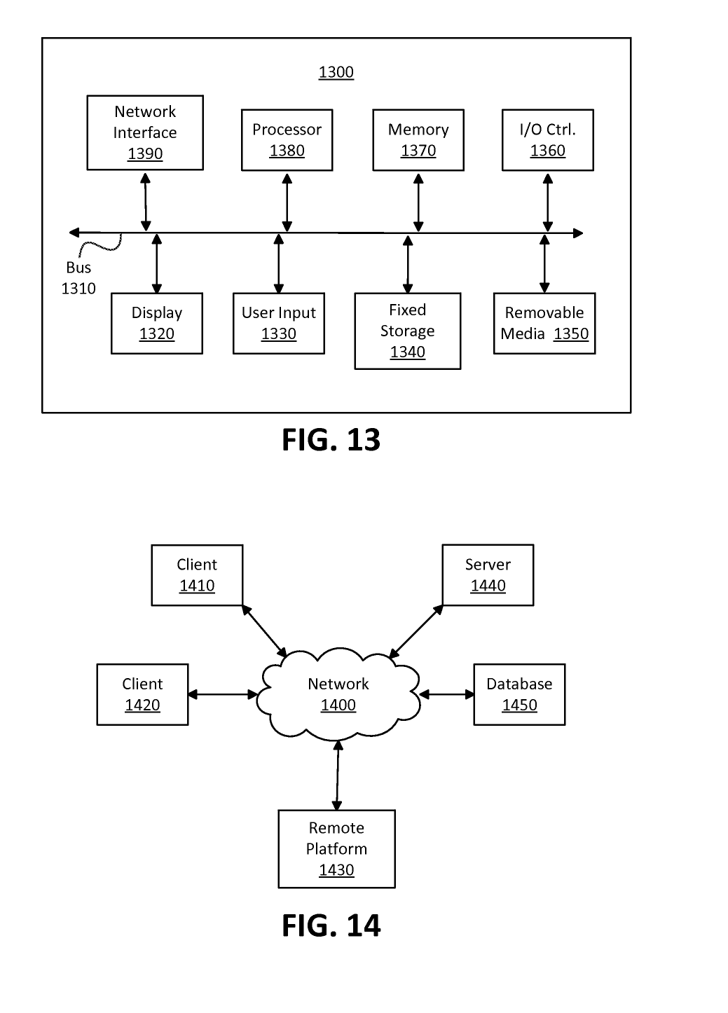

Implementations of the presently disclosed subject matter may be implemented in and used with a variety of component and network architectures. FIG. 13 is an example computer 1300 suitable for implementations of the presently disclosed subject matter. The computer 1300 includes a bus 1310 which interconnects major components of the computer 1300, such as a central processor 1380, a memory 1370 (typically RAM, but which may also include ROM, flash RAM, or the like), an input/output controller 1360, a user display 1320, such as a display screen via a display adapter, a user input interface 1330, which may include one or more controllers and associated user input devices such as a keyboard, mouse, and the like, and may be closely coupled to the I/O controller 1360, fixed storage 1340, such as a hard drive, flash storage, Fibre Channel network, SAN device, SCSI device, and the like, and a removable media component 1350 operative to control and receive an optical disk, flash drive, and the like.

The bus 1310 allows data communication between the central processor 1380 and the memory 1370, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 1300 are generally stored on and accessed via a computer readable medium, such as a hard disk drive (e.g., fixed storage 1340), an optical drive, floppy disk, or other storage medium.

The fixed storage 1330 may be integral with the computer 1300 or may be separate and accessed through other interfaces. A network interface 1390 may provide a direct connection to a remote server via a telephone link, to the Internet via an internet service provider (ISP), or a direct connection to a remote server via a direct network link to the Internet via a POP (point of presence) or other technique. The network interface 1390 may provide such connection using wireless techniques, including digital cellular telephone connection, Cellular Digital Packet Data (CDPD) connection, digital satellite data connection or the like. For example, the network interface 1390 may allow the computer to communicate with other computers via one or more local, wide-area, or other networks, as shown in FIG. 14.

Many other devices or components (not shown) may be connected in a similar manner (e.g., document scanners, digital cameras and so on). Conversely, all of the components shown in FIG. 13 need not be present to practice the present disclosure. The components can be interconnected in different ways from that shown. The operation of a computer such as that shown in FIG. 13 is readily known in the art and is not discussed in detail in this application. Code to implement the present disclosure can be stored in computer-readable storage media such as one or more of the memory 1370, fixed storage 1340, removable media 1350, or on a remote storage location.

FIG. 14 shows an example network arrangement according to an implementation of the disclosed subject matter. One or more clients 1410, 1420, such as local computers, smart phones, tablet computing devices, and the like may connect to other devices via one or more networks 1400. The network may be a local network, wide-area network, the Internet, or any other suitable communication network or networks, and may be implemented on any suitable platform including wired and/or wireless networks. The clients may communicate with one or more servers 1440 and/or databases 1450. The devices may be directly accessible by the clients 1410, 1420, or one or more other devices may provide intermediary access such as where a server 1440 provides access to resources stored in a database 1450. The clients 1410, 1420 also may access remote platforms 1430 or services provided by remote platforms 1430 such as cloud computing arrangements and services. The remote platform 1430 may include one or more servers 1440 and/or databases 1450.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

In situations in which the implementations of the disclosed subject matter collect personal information about users, or may make use of personal information, the users may be provided with an opportunity to control whether programs or features collect user information (e.g., a user's game score, a user's work product, a user's provided input, a user's geographic location, and any other similar data associated with a user), or to control whether and/or how to receive shared content from a content distribution system, game developer, or social network member that may be more relevant to the user. In addition, certain data may be treated in one or more ways before it is stored or used, so that personally identifiable information is removed. For example, a user's identity may be treated so that no personally identifiable information can be determined for the user, or a user's geographic location associated with social network information may be generalized where location information is obtained (such as to a city, ZIP code, or state level), so that a particular location of a user cannot be determined. Thus, the user may have control over how information is collected about the user and used by content distribution systems, social network systems, or content developers.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method comprising:
providing, by a content distribution system, access to an interactive content to a plurality of users;
obtaining, for each user of the plurality of users, a social media data indicating an interaction level of each user of the plurality of users with one or more social media systems;
determining a content sharing rating for each user of the plurality of users based on the social media data;
selecting a first user from among the plurality of users based on the first user's content sharing rating;
determining a recommendation for an incentive to be provided to the first user within the interactive content, in exchange for the first user performing an action to connect the interactive content to an account of the first user on a social media system; and
providing the recommendation to an administrative system that administers the interactive content and that is distinct from the content distribution system.

2. The method of claim 1, further comprising:
providing an indication of the incentive and an indication of the action to the first user;
receiving a confirmation that the first user performed the action; and
responsive to receiving the confirmation, providing the incentive to the first user within the interactive content.

3. The method of claim 1, further comprising:
receiving, at the content distribution system, a confirmation that the first user performed the action; and
updating the first user's content sharing rating based on the confirmation.

4. The method of claim 1, further comprising:
receiving, at the content distribution system, a request to download the interactive content resulting from a link posted by the first user on a social media system; and
distributing, by the content distribution system, the interactive content to a device.

5. The method of claim 1 wherein the interactive content comprises a game accessible on a device associated with the first user.

6. The method of claim 1 wherein the social media data comprises a social graph of a particular user of the plurality of users that indicates relations in a social media system between the particular user and other users of the social media system.

7. The method of claim 1 wherein the social media data comprises a number of actions performed by a particular user of the plurality of users to connect an interactive content to an account of the particular user on a social media system.

8. The method of claim 1 wherein the social media data comprises a number of actions performed by a user of the plurality of users to post a link to an interactive content on a social media system.

9. The method of claim 1 wherein the social media data comprises:
a number of actions performed by a particular user of the plurality of users to post a link to a particular interactive content on a social media system; and
a number of actions performed by users of the social media system to access the particular interactive content via the link.

10. The method of claim 1 wherein the social media data comprises:
a number of relations on a social media system between a particular user of the plurality of users and users of the social media system; and
a number of actions performed by users of the social media system to access a particular interactive content via a link posted on the social media system by the particular user to the particular content.

11. The method of claim 1 wherein determining the content sharing for each user of the plurality of users based on the social media data comprises:
determining a ratio between a number of actions performed by users of a social media system to access a particular interactive content via a link on the social media system that is posted by a particular user to the particular content, and a number of relations in the social media system between the particular user and users of the social media system.

12. The method of claim 1 wherein determining the content sharing rating for each user of the plurality of users based on the social media data is based on:
a determined ratio between a number of actions performed by users of a social media system to access a particular interactive content via a link on the social media system that is posted by a particular user to the particular content, and a number of relations in the social media system between the particular user and users of the social media system; and
a number of actions performed by the particular user to post a link to an interactive content on the social media system.

13. The method of claim 1 wherein determining the content sharing rating for each user of the plurality of users based on the social media data comprises:
determining whether a particular interactive content was provided by the content distribution system, wherein the particular interactive content was made accessible via a link on a social media system by a user of the plurality of users.

14. The method of claim 1 wherein selecting the first user from among the plurality of users based on the first user's content sharing rating comprises comparing the first user's content sharing rating to a content sharing rating of another user of the plurality of users.

15. The method of claim 1 wherein selecting the first user from among the plurality of users based on the first user's content sharing rating comprises comparing the first user's content sharing rating to a threshold rating.

16. The method of claim 1 wherein the determining the recommendation is based on the first user's content sharing rating.

17. The method of claim 1 wherein the determining the recommendation is based on an incentive history data indicating a history of responses of the first user to incentives within interactive content, and
wherein the incentive history data comprises at least one of the group consisting of a response of the first user to a prompt to connect interactive content to an account of the first user on a social media system.

18. The method of claim 1 wherein the determining the recommendation is based on an incentive history data indicating a history of responses of the first user to incentives within interactive content, and
wherein the incentive history data comprises at least one of the group consisting of: a response of the first user to a prompt to connect interactive content to an account of the first user on a social media system, a response of the first user to a prompt to view an advertisement, and a response of the first user to a prompt to transfer a unit of monetary value from the first user.

19. The method of claim 1 wherein the determining the recommendation is based on an interactive content history data indicating a history of interaction of each user of the plurality of users with interactive content.

20. The method of claim 1 wherein the determining the recommendation is based on an interactive content history data indicating a history of interaction of each user of the plurality of users with one or more games.

21. The method of claim 1 wherein the recommendation comprises a recommendation of a user account of the social media system, and wherein the action comprises posting a link to the interactive content to the user account.

22. The method of claim 1 wherein the incentive comprises access to additional content within the interactive content.

23. The method of claim 1 wherein the interactive content comprises a game, and wherein the incentive comprises access in the game to at least one of the group consisting of a game level, a map, a quest, storyline, a character, a population, a unit, a tool, a weapon, an ammunition, a health level, a currency, a food, a skill, a power, and an experience level.

24. The method of claim 1 wherein the action to connect the interactive content to the account of the first user on the social media system comprises posting a link to the interactive content on the social media system.

25. The method of claim 1 wherein the administrative system comprises an entity that developed the interactive content.

26. A method comprising:
providing, by a content distribution system, access to a first interactive content to a plurality of users;
obtaining, for a first user of the plurality of users, a social media data indicating an interaction level of the first user with one or more social media systems;
determining a content sharing rating for the first user based on the social media data;
obtaining, for the first user, an incentive history data indicating a history of responses of the first user to incentives within interactive content;
determining, based on the content sharing rating and the incentive history data, a recommendation of an incentive to be provided to the first user within the first interactive content in exchange for the first user performing an action associated with the first interactive content; and
providing the recommendation to a system that administers the first interactive content and that is distinct from the content distribution system.

27. The method of claim 26, further comprising:
obtaining, for a second user of the plurality of users, an interactive content history data indicating a history of interaction of the second user with a second interactive content;
determining a first content category of the first interactive content and a second content category of the interactive content history data; and
wherein the determining the recommendation comprises comparing the first content category to the second content category.

28. A system comprising:
a server storing an interactive content; and
a processor in communication with the server and configured to execute instructions for:
providing access to the interactive content to a plurality of users;
obtaining, for each user of the plurality of users, a social media data indicating an interaction level of each user of the plurality of users with one or more social media systems;
determining a content sharing rating for each user of the plurality of users based on the social media data;
selecting a first user from among the plurality of users based on the first user's content sharing rating;
selecting a first incentive, from among a plurality of incentives, to be provided to the first user in exchange for the first user performing an action to connect the interactive content to an account of the first user on a particular social media system;
providing an indication of the incentive and an indication of the action to the first user;
receiving a confirmation that the first user performed the action; and
responsive to receiving the confirmation, providing the incentive to the first user within the interactive content.

29. The system of claim 28 wherein receiving the confirmation comprises receiving an indication that the interactive content was accessed from a link to the interactive content posted by the first user to the particular social media system.
